(19) United States
(12) Patent Application Publication
(10) Pub. No.: US 2017/0350203 A1
(43) Pub. Date: Dec. 7, 2017

(54) Electrically-Actuated Slip Devices

(71) Applicant: Baker Hughes Incorporated, Houston, TX (US)

(72) Inventor: Ellen Ellis Rud, Houston, TX (US)

(73) Assignee: Baker Hughes Incorporated, Houston, TX (US)

(21) Appl. No.: 15/174,662

(22) Filed: Jun. 6, 2016

(51) Int. Cl. E21B 23/01; H01F 7/06

(52) U.S. Cl. CPC E21B 23/01; H01F 7/06

(57) ABSTRACT

Slip devices include a slip element that is moved radially outwardly by an electrical solenoid actuator.

### BACKGROUND OF THE INVENTION

### 1. Field of the Invention

The invention relates generally to slip devices and arrangements for setting such devices within a wellbore or other surrounding tubular member.

### 2. Description of the Related Art

Slip devices, or slips, are typically devices used to mechanically anchor a work string within a wellbore. Slips can be incorporated into a work string and are often located adjacent to a packer element which can be set to provide a fluid seal within the wellbore. Slips normally include toothed slip elements that are radially moveable outwardly from an initial, unset position to a set position so that the teeth of the slip element will bite into the wellbore wall. Variations of slips can include scraper blocks or drag blocks which frictionally engage the sidewall of a wellbore or other tubular member but allow for some relative movement.

Traditionally, slips are set by axially moving a setting sleeve upon a mandrel. The setting sleeve is moved by applied hydraulic pressure.

### SUMMARY OF THE INVENTION

The present invention relates to systems and methods for setting slip devices within a wellbore using electrical motive force, preferably provided from the surface. A first exemplary slip device in accordance with the present invention is described in context of a packer assembly which incorporates slip devices. An electric solenoid actuator is used to move the setting sleeve of the slip device. Alternative slip devices are described in which an electric solenoid actuator directly drives the slip element to its set position and wherein a setting piston is moved by the solenoid actuator to set the slip element. Slip devices are also described in which the slip elements are scraper or drag blocks which frictionally engage a surrounding tubular. Electrical power could be supplied to the solenoid actuator from surface via an electrical conduit. Alternatively, power is supplied to the solenoid actuator from a downhole power source. The force applied by the slip device is proportional to the current applied to the actuator. Particular embodiments include an electric current controller which is configured to control the amount of current provided to the solenoid actuator and thereby govern the setting force.

### BRIEF DESCRIPTION OF THE DRAWINGS

For a thorough understanding of the present invention, reference is made to the following detailed description of the preferred embodiments, taken in conjunction with the accompanying drawings, wherein like reference numerals designate like or similar elements throughout the several figures of the drawings and wherein:

FIG. 1 is a side, cross-sectional view of a wellbore containing a work string with a slip device constructed in accordance with the present invention.

FIG. 2 is an enlarged, side cross-sectional view of the packer assembly which contains slip devices in accordance with the present invention.

FIG. 3 is an enlarged, side cross-sectional view of the packer assembly of FIG. 2 now in a set condition.

FIG. 4 is a side, cross-sectional view of an alternative slip device constructed in accordance with the present invention.

FIG. 5 is a side, cross-sectional view of a further alternative slip device constructed in accordance with the present invention.

### DETAILED DESCRIPTION OF THE PREFERRED EMBODIMENTS

The term “slip,” as used herein, is intended to refer broadly to elements which are moved outwardly from a wellbore work string and into engagement with a surrounding casing or tubing. A slip can be an anchoring-type slip which typically includes a toothed engagement surface for creating a biting engagement with the surrounding tubular. In addition, a slip could be a scraper block or drag block element which will engage the surrounding tubular frictionally.

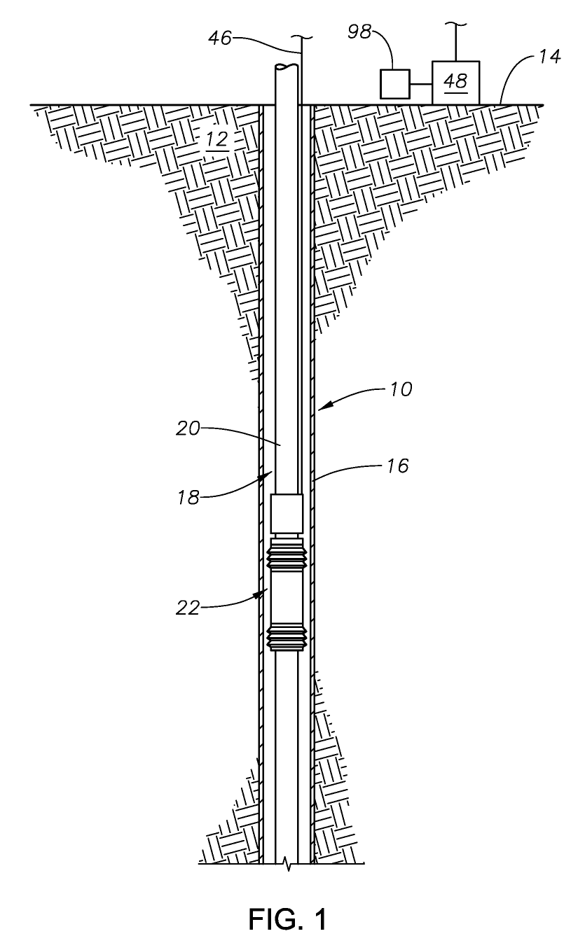

FIG. 1 illustrates an exemplary wellbore 10 which has been drilled through the earth 12 from the surface 14. The wellbore 10 is lined with metallic casing 16. A work string 18 is disposed in the wellbore 10 from the surface 14. The work string 18 may be a production arrangement, a work-over string or be of other configurations. The work string 18 includes a running string 20 which may be made up of convention oilfield tubulars or, alternatively, coiled tubing. The running string 20 may be used to carry and transport a bottom hole assembly (not shown) into the wellbore 10, as is known in the art.

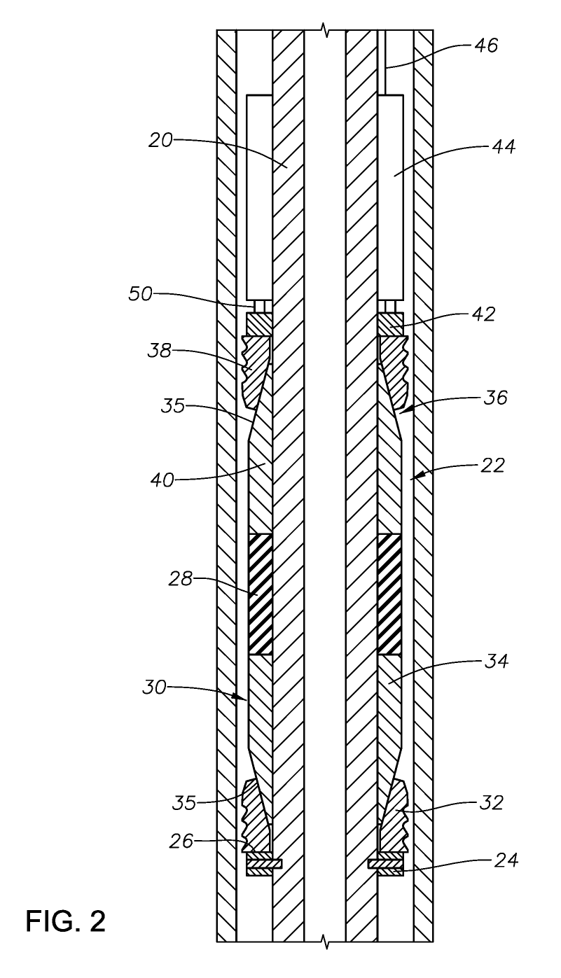

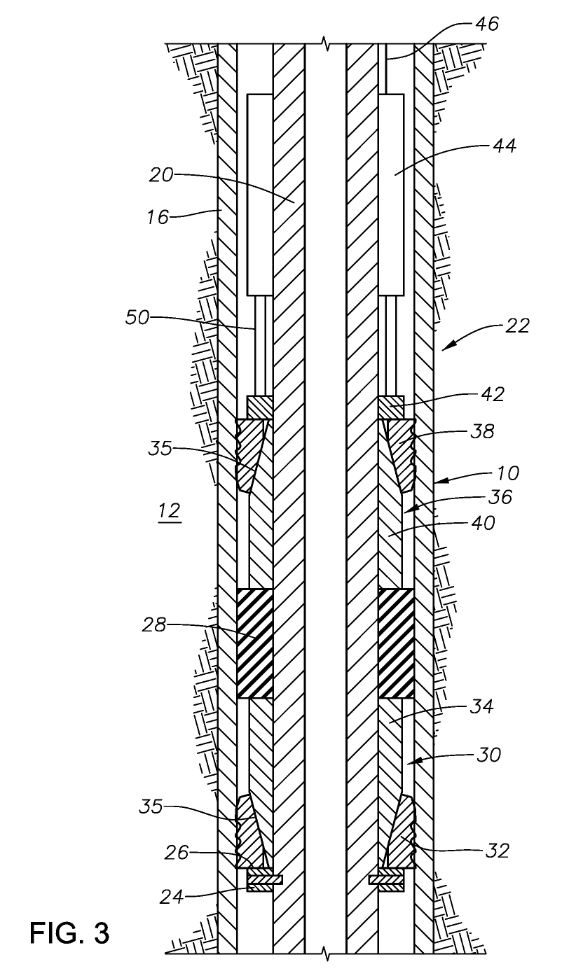

A packer assembly, generally indicated at 22 is incorporated into the running string 20 and is used to anchor the running string 20 within the wellbore 10. The packer assembly 22 is shown in greater detail in FIGS. 2 and 3. Annular ring 24 is affixed to the running string 20 at the lower end of the packer assembly 22. The ring 24 presents an upward axially-facing stop shoulder 26.

The packer assembly 22 includes an annular, elastomeric, compression-set packer element 28 of a type known in the art which radially surrounds the running string 20. A lower slip device 30 is located above the ring 24 and includes toothed slip element 32 and a setting ramp ring 34. In the depicted embodiment, the slip element 32 is an annular member which will rupture when expanded radially outwardly. The lower slip device 30 is preferably located axially below the packer element 28. The setting ramp ring 34 presents an angled ramp surface 35 which contacts the slip element 32. When the setting ramp ring 34 is moved axially, the angled ramp surface 35 will urge the slip element 32 radially outwardly.

An upper slip device 36 is located axially above the packer element 28. The upper slip device 36 includes toothed slip element 38 and a setting ramp ring 40. Preferably, the slip element 38 and setting ramp ring 40 have the same construction as the slip element 32 and setting ramp ring 34 described previously. A setting sleeve 42 is adjacent to the slip elements 38 of the upper slip device 36, and the ring 24 is adjacent the slip elements 32 of the lower slip device 30.

An electrically-actuated solenoid actuator 44 surrounds the running string 20. The solenoid actuator 44 generally converts electrical energy to linear movement of a plunger or piston member. The solenoid actuator 44 includes an electrical coil which is energized to move the plunger or piston member. An electrical conduit 46 extends from a power source 48 at surface 14 down to the solenoid actuator 44. The power source 48 may be an electrical generator. The solenoid actuator 44 includes one or more actuating pistons 50 which is/are telescopically extendable from the actuator 44 to exert axial force upon the setting ring 42. This force also causes the setting ramp rings 34, 40 to be moved axially upon the running string 20 to urge the slip elements 32, 38 radially outwardly and into biting engagement with the surrounding casing 16.

In operation, the work string 18 is run into the wellbore 10 to a desired depth or location. During run-in, the packer assembly 22 is in the unset condition shown in FIG. 2. The packer assembly 22 is then moved from the unset position (FIG. 2) to the set position (FIG. 3) by energizing the solenoid actuator 44. The packer element 28 and the upper, and lower slip devices 36, 30 are axially compressed. The slip elements 32, 38 are moved radially outwardly into anchoring engagement with the casing 16. In addition, the packer element 28 is expanded radially outwardly into sealing engagement with the casing 16. While the slip assemblies 30, 36 are described and shown anchoring a running string 20 within a wellbore 10, it should be understood that the slip arrangements of the present invention are useful for anchoring any tubular member within a surrounding tubular member.

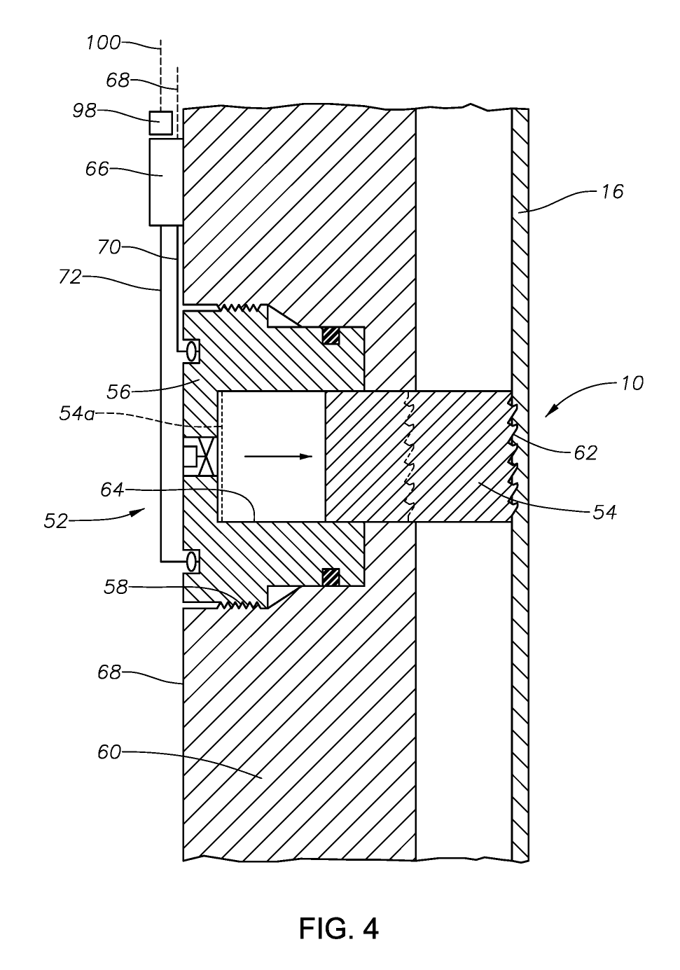

FIG. 4 depicts an alternative slip device 52 wherein a slip element 54 is driven directly by its solenoid actuator 56. The solenoid actuator 56 is secured within a threaded opening 58 in a housing 60. The housing 60 may be the outer housing of a downhole tool or a portion of a running string. The slip element 54 is preferably a generally cylindrical member which presents an engagement surface 62 which is toothed or otherwise shaped to bitingly engage the casing 16 when the slip element 54 is in a radially extended position. The slip element 54 resides within central opening 64 of the solenoid actuator 56 and is moveable between a radially contracted position (indicated by broken lines 54a in FIG. 4) and a radially extended position (shown by the solid lines in FIG. 4). When the solenoid actuator 56 is energized, the slip element 54 will be moved from the radially contracted position to the radially extended position. The solenoid actuator 56 is operably associated with a downhole power source 66. As illustrated in FIG. 4, the downhole power source 56 is located within the flowbore 68 of the housing 60. However, it may be placed in other downhole locations. The downhole power source 56 is preferably a battery which is capable of supplying a current of between about 4 to about 20 mA. Lead wires 70, 72 extend from the downhole power source 66 to the solenoid actuator 56 to deliver electric power. Preferably, the downhole power source 66 is controlled from surface 14 to energize the solenoid actuator 56 at a desired time. Control communication from surface 14 may be by wire (i.e., data line) or by wireless communication, as illustrated by broken line 68.

In operation, the housing 60 with slip device 52 is disposed into the wellbore 10. During run-in, the slip element 54 is in the radially contracted position depicted at 54a. When the slip device 52 is at the desired depth or location within the wellbore 10, the solenoid actuator 56 is energized to move the slip element 54 radially outwardly to its radially extended position and create biting engagement with the surrounding casing 16. In preferred embodiments, the force used to urge the slip element 54 outwardly is proportional to the current that is applied to the solenoid actuator 56 by the downhole power source 66. Therefore, an operator can increase the current that is provided to the solenoid actuator 56 in order to increase the setting force of the slip element 54.

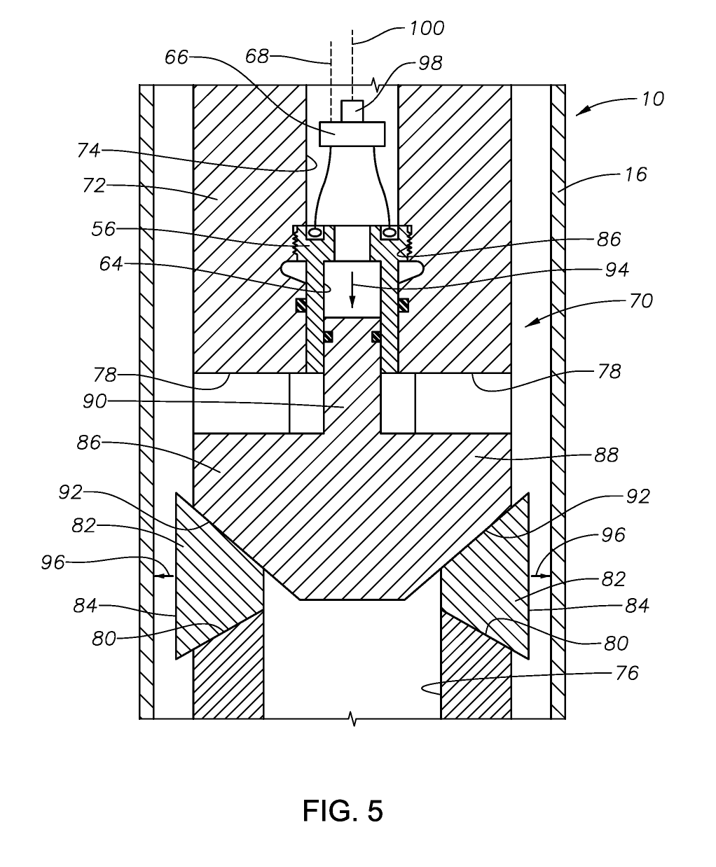

FIG. 5 illustrates a further alternative embodiment for a slip device 70 wherein scraper or drag block-type slip elements are extended radially outwardly from a housing by a solenoid actuator. The slip device 70 includes a generally cylindrical tool housing 72 which may be incorporated into or affixed to a running string, such as running string 20. An upper central bore 74 is formed within the tool housing 72. A lower central bore 76 is also formed within the tool housing 72. The lower central bore 76 preferably has a larger diameter than the upper central bore 74. Lateral windows 78 are formed within the tool housing 72. In the depicted embodiment, there are two lateral windows 78. However, there may be more or fewer than two such lateral windows, if desired. In preferred embodiments, the lower end of each lateral window 78 provides an angled ramp surface 80. A scraper or drag blocks 82 are disposed within each of the lateral windows 78. Each of the scraper or drag blocks 82 can move between radially contracted positions and radially extended positions. Each of the scraper or drag blocks 82 are preferably wedge shaped and present an outer contact surface 84 which will frictionally contact and slide upon surrounding casing 16 when in its radially extended position.

A solenoid actuator 56 is secured within a threaded opening 86 in the housing 72 just below the upper central bore 74. A downhole power supply 66 is operably interconnected with the solenoid actuator 56 to supply current to the solenoid actuator 56. The downhole power supply 66 is preferably located within the upper central bore 74. A wired or wireless communication line 68 extends to surface 14 from the downhole power supply 66. A piston member 86 is moved by the solenoid actuator 56. The piston member 86 includes an enlarged piston head 88 and a shaft portion 90. The shaft portion 90 resides within the central opening 64 of the solenoid actuator 56. The enlarged piston head 88 presents angled ramp surfaces 92 which contact the scraper or drag blocks 82. When the solenoid actuator 56 is energized, the piston member 86 is moved downwardly in the direction of arrow 94. As the piston member 86 is moved downwardly, the scraper or drag blocks 82 are urged radially outwardly as illustrated by the arrows 96 toward their radially extended positions. Interaction of the angled ramp surfaces 92 and 80 with the wedge shaped blocks 82 will cause the scraper or drag blocks 82 to their radially extended positions and into contact with the surrounding casing 16.

In operation, the slip device 70 is run into the wellbore 10. When the slip device 70 is at a desired depth or location within the wellbore 10, a command is sent via communication line 68 to the downhole power source 66. The downhole power source 66 is turned on to energize the solenoid actuator 56 and cause the piston member 86 to move downwardly, thereby urging the scraper or drag blocks 82 radially outwardly and into contact with the surrounding casing 16. The scraper or drag blocks 82 will function to arrest movement of the slip device 70 within the wellbore 10.

It is noted that in each of the previously described embodiments, an operator may adjust the setting force used to set the slip element or scraper or drag block by adjusting the amount of current that is provided to the solenoid actuator 44 or 56. Typically, an operator would determine a specific level of setting force for setting of the slip element 32, 38, 54 or 82. Ordinarily, a lesser setting force would be desired for a scraper or drag block slip element, such as slip elements 82. A greater setting force would be desired to create a biting engagement of an anchoring slip element, such as toothed slip elements 32, 38 or 54. Current can then be governed to result in an appropriate level of setting force to the slip element(s) 32, 38, 54 or 82. One mechanism for governing the level of current is a current controller (98 in FIGS. 4-5) in the form of a downhole communications module which is operably associated with the downhole power source 66 and configured to control the level of current which is provided from the downhole power source 66 to the solenoid actuator 56. Communication from surface 14 with the current controller 98 is indicated by the broken line 100 in FIGS. 4-5. Communication may be via physical data line, wireless or pressure pulse sequence or by other communication techniques known in the art. The downhole current controller 98 is configured to control the amount of current that is transmitted from the downhole power source 66 to the solenoid actuator 56. This mechanism may be a rheostat or electronic circuitry which is capable of controlling the amount of current that is transmitted to the solenoid actuator 56. A current controller device 98 may also be used with the arrangement of FIGS. 1-3 and would be preferably located at surface 14 and operably associated with the power source 48.

In certain aspects, the invention provides methods for setting a slip device within a surrounding tubular, such as casing 16, within a wellbore 10. In accordance with these methods, a slip device 30, 36, 52 or 70 is run into a wellbore 10. A solenoid actuator 44 or 56 is then energized to move a slip element 32, 38, 54 or 82 from a radially contracted position to a radially extended position. Electrical power is provided to the solenoid actuator 44 or 56 from a power source 48 or 66 in order to energize the solenoid actuator 44, 56. In accordance with particular embodiments, the setting force used to set the slip element 32, 38, 54 or 82 is controlled by adjustment of current provided to the solenoid actuator 44 or 56.

Those of skill in the art will recognize that numerous modifications and changes may be made to the exemplary designs and embodiments described herein and that the invention is limited only by the claims that follow and any equivalents thereof.

What is claimed is:

1. A slip device for anchoring a tubular member within a surrounding tubular, the slip device comprising:
a slip element that is radially moveable between a radially contracted position and a radially expanded position, the slip element being configured to engage the surrounding tubular in the radially expanded position; and
an electrical solenoid actuator to move the slip element from the radially contracted position to the radially expanded position.

2. The slip device of claim 1 wherein the slip element comprises an anchoring slip element having a toothed engagement surface for forming a biting engagement with the surrounding tubular.

3. The slip device of claim 1 wherein the slip element comprises a scraper block which presents a contact surface for frictionally engaging the surrounding tubular.

4. The slip device of claim 1 further comprising:
a setting ramp ring that is axially shiftable to move the slip element from the radially contracted position to the radially expanded position; and
wherein the setting ramp ring has an angled ramp surface to urge the slip element radially outwardly as the setting ramp ring is moved axially by the solenoid actuator.

5. The slip device of claim 1 wherein setting force for the slip element is adjusted by adjusting an amount of current supplied to the solenoid actuator.

6. The slip device of claim 1 wherein the solenoid actuator moves the slip element by moving a piston member, the piston member having angled surfaces which urge the slip element radially outwardly.

7. The slip device of claim 1 wherein the slip element is moved directly by the solenoid actuator.

8. The slip device of claim 1 further comprising a current controller for controlling setting force for the slip member by adjustment of electrical current supplied to the solenoid actuator.

9. A slip device for anchoring a tubular member within a surrounding tubular, the slip device comprising:
a slip element that is radially moveable between a radially contracted position and a radially expanded position, the slip element being configured to engage the surrounding tubular in the radially expanded position;
an electrical solenoid actuator to move the slip element from the radially contracted position to the radially expanded position; and
a power supply to provide electric power to energize the solenoid actuator.

10. The slip device of claim 9 wherein the slip element comprises an anchoring slip element having a toothed engagement surface for forming a biting engagement with the surrounding tubular.

11. The slip device of claim 9 wherein the slip element comprises a scraper block which presents a contact surface for frictionally engaging the surrounding tubular.

12. The slip device of claim 9 further comprising:
a setting ramp ring that is axially shiftable to move the slip element from the radially contracted position to the radially expanded position; and
wherein the setting ramp ring has an angled ramp surface to urge the slip element radially outwardly as the setting ramp ring is moved axially by the solenoid actuator.

13. The slip device of claim 9 wherein setting force for the slip element is adjusted by adjusting an amount of current supplied to the solenoid actuator.

14. The slip device of claim 9 wherein the solenoid actuator moves the slip element by moving a piston member, the piston member having angled surfaces which urge the slip element radially outwardly.

15. The slip device of claim 9 wherein the slip element is moved directly by the solenoid actuator.

16. The slip device of claim 9 further comprising a current controller for controlling setting force for the slip member by adjustment of electrical current supplied to the solenoid actuator.

17. A method of setting a slip device within a surrounding tubular in a wellbore, the method comprising the steps of:
disposing a slip device into a wellbore; and
actuating an electric solenoid actuator to move a slip element from a radially contracted position to a radially expanded position.

18. The method of claim 17 further comprising the step of controlling setting force for the slip element by adjusting current supplied to the solenoid actuator.
